(19) United States
(12) Patent Application Publication
(10) Pub. No.: US 2023/0289197 A1
(43) Pub. Date: Sep. 14, 2023

(54) ACCELERATOR MONITORING FRAMEWORK

(71) Applicant: Intel Corporation, Santa Clara, CA (US)

(72) Inventors: Gordon MCFADDEN, Beaverton, OR (US); Laurent COQUEREL, Limerick (IE); Fei Z. WANG, Shannon (IE); John J. BROWNE, Limerick (IE)

(21) Appl. No.: 18/130,415

(22) Filed: Apr. 3, 2023

(51) Int. Cl. G06F 9/445; G06F 12/02

(52) U.S. Cl. CPC G06F 9/44505; G06F 12/0292; G06F 2212/7201

(57) ABSTRACT

A method is described. The method includes repeatedly reading accelerator telemetry data from register and/or memory space allocated for the keeping of the accelerator telemetry data and writing the accelerator telemetry data into a physical file structure within memory and/or mass storage. The method also includes repeatedly reading the accelerator telemetry data from the physical file structure and storing the accelerator telemetry data into virtual files that are visible to application software programs that invoke the accelerator. The accelerator telemetry data describes an input/output memory management unit’s performance regarding its translation of virtual addresses to physical addresses for the accelerator.

### BACKGROUND OF THE INVENTION

With data center computing environments continuing to rely on high speed, high bandwidth networks to interconnect their various computing components, system managers are increasingly interested in monitoring the performance of the data center’s various functional components.

### BRIEF DESCRIPTION OF THE DRAWINGS

FIG. 1 shows an accelerator and associated hardware;

FIG. 2 shows a first architecture for monitoring performance statistics of the accelerator;

FIG. 3 shows a second architecture for monitoring performance statistics of the accelerator;

FIG. 4 shows a computing environment;

FIGS. 5a and 5b depict an IPU.

### DETAILED DESCRIPTION

One way to increase the performance of an application that relies on numerically intensive computations is to off load the computations from the application to an accelerator that is specially designed to perform the computations. Here, commonly, the processing core that the application is executing upon is a general purpose processing core that would consume many hundreds or thousands of program code instructions (or more) to perform the numerically complex computations.

By off-loading the computations to an accelerator (e.g., an ASIC block, a special purpose processor, etc.) that is specially designed to perform these computations (e.g., primarily in hardware), the respective processing times of the computations can be greatly reduced.

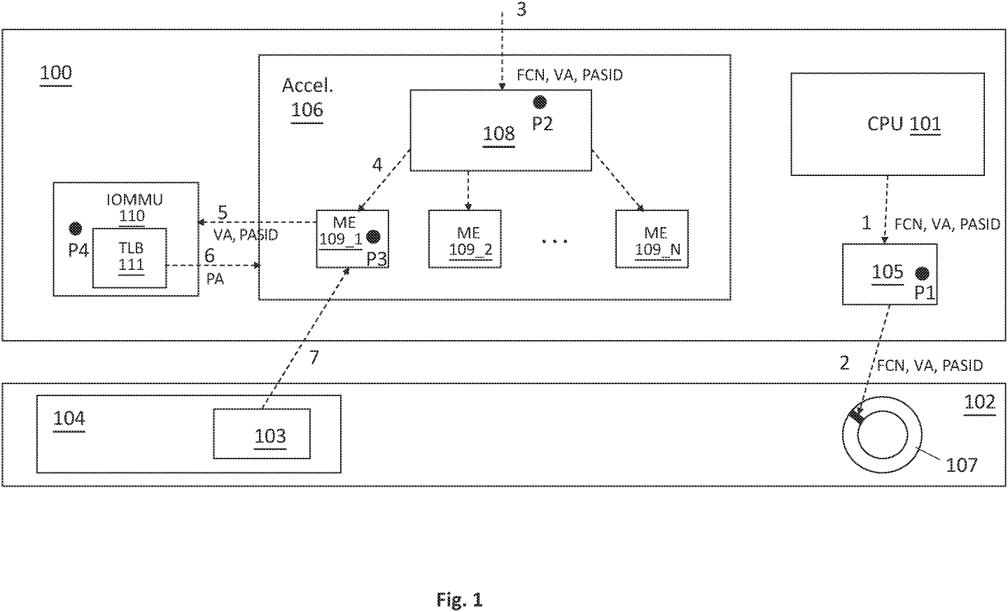

FIG. 1 shows a high-level view of an accelerator 106 and its associated hardware. As observed in FIG. 1, the accelerator 106 is integrated within a hardware platform 100 that includes a general-purpose processing core (CPU) 101 that is executing one or more application software programs. As just one possible embodiment, hardware platform 100 is a system-on-chip in which the CPU core 101 and accelerator 106 are integrated on a same semiconductor chip.

An application software program executes on the CPU core 101 out of a region 104 of system memory 102 that has been allocated to the application. Here, during runtime, the CPU 101 reads the application’s data and program code instructions from the application’s allocated memory region 104 and then executes the instructions to process the data. The CPU 101 likewise writes new data structures created by the executing application into the application’s region 104 of system memory 102.

When the application invokes the accelerator 106 to perform a mathematically intensive computation one on of the application’s data structures 103, a descriptor is passed 1 from the CPU 101 to logic circuitry 105 that implements one or more queues in memory 102 that feed the accelerator 106. The descriptor identifies the function (FCN) that the accelerator 106 is to perform on the data structure 103 (e.g., cryptographic encoding, cryptographic decoding, compression, decompression, neural network processing, artificial intelligence machine learning, artificial intelligence inferencing, image processing, machine vision, graphics processing, etc.), the virtual address (VA) of the data structure 103, and an identifier of the CPU process that is executing the application (PASID).

Here, the application is written to refer to virtual memory addresses. The application’s kernel space (which can include an operating system instance (OS) that executes on a virtual machine (VM), and a virtual machine monitor (VMM) or hypervisor that the supports the VM’s execution) comprehends the true amount of physical address space that exists in physical memory 102, allocates the portion 104 of the physical address space to the application, and configures the CPU 101 to convert, whenever the application issues a read/write request to/from memory 102, the virtual memory address specified by the application in the request to a corresponding physical memory addresses that falls within the application’s allocated portion of memory 104.

Thus, the descriptor that is passed 1 to the queuing logic 105 specifies the virtual address of data structure 103 and not its physical address. Queueing logic 105 is designed to cause memory space within the memory 102 that is allocated to the accelerator 106 to behave as a circular buffer 107. Essentially, queuing logic 105 is designed to: 1) read a next descriptor to be serviced by the accelerator 106 from the buffer 107 at a location pointed to by a head pointer; 2) rotate the head pointer about the address range of the buffer 107 as descriptors are continuously read from the buffer 107; 3) write each new descriptor to a location within the buffer 107 pointed to by a tail pointer; 4) rotate the tail pointer about the buffer’s address range in a direction opposite to 3) above as new descriptors are continuously entered into the buffer 107.

In response to its receipt 1 of the descriptor, the queuing logic 105 writes 2 the descriptor into the buffer 107 at a location pointed to by the buffer’s tail pointer. The accelerator’s firmware (not shown in FIG. 1) monitors the processing activity of the accelerator 106 and recognizes when the accelerator 106 is ready to process a next data structure (the accelerator firmware executes, e.g., on an embedded processor within the accelerator 106). When the accelerator 106 is ready to process a next data structure and the buffer’s head pointer points to the descriptor that was entered 2 for data structure 103, the descriptor is read from the buffer 107 and processed by the accelerator’s firmware. The firmware then programs registers 3 within the accelerator 106 with the descriptor information.

In various embodiments, the queuing logic 105 implements more than one ring buffer in memory 102, and, the accelerator 106 can service descriptors from any/all of such multiple buffers. Here, the accelerator firmware can be designed to balance between fairness (e.g., servicing the multiple queues in round-robin fashion) and performance (e.g., servicing queues having more descriptors ahead of other queues having less descriptors). Here, for example, a set of one or more such queues can be instantiated in memory for each application that is configured to invoke the accelerator 106 (e.g., each application has its own dedicated ring buffer 107 in memory 102).

As observed in FIG. 1, the accelerator includes multiple special purpose cores (“microengines” (MEs)) 109_1 through 109_N that are individual engines for performing the accelerator’s numerically intensive tasks. Here, with N MEs 109, the accelerator 106 is able to concurrently process N function calls (“invocations”) from one or more applications. That is, the accelerator can concurrently perform respective numerically intensive computations on N different data structures (one for each ME).

A workload manager (“dispatcher”) within the accelerator 106 assigns new jobs (as received by the programming of information 3 from a next descriptor) to the MEs for subsequent execution. In the particular example of FIG. 1, the dispatcher 108 assigns the job 4 for data structure 103 to ME 109_1.

Notably, depending on implementation, the accelerator can include one or more internal queues (not shown) that feed the dispatcher 108. In this case, the firmware writes descriptor information 3 into the tail of such a queue. The dispatcher 108 then pulls a next descriptor from the head of the queue when a next core ME is ready to process a next job. Alternatively, each ME has its own dedicated queue and the dispatcher 108 places new jobs into the queue having the least amount of jobs to perform.

Depending on implementation, there can be one internal queue within the accelerator 106 for each ME 109, or, a different queue for each type of computation the accelerators MEs are configured to perform (explained immediately below), or, one internal queue that feeds all the MEs 109, or, some other arrangement of internal queues and how they feed the MEs 109.

Notably, in various embodiments, the MEs are configurable to perform a certain type of computation. For example, each of MEs 109_1 through 109_N can be configured to perform any one of: 1) key encryption/decryption (e.g., public key encryption/decryption); 2) symmetrical encryption/decryption; 3) compression/decompression. Here, the dispatcher 108 assigns each job to an ME that has been configured to perform the type of computation that the job’s called function corresponds to.

Furthermore, in various embodiments, the accelerator’s firmware and dispatcher 108 can be configured to logically couple certain ring buffers in memory 102 to certain MEs 109 in the accelerator. Here, for instance, if a ring buffer is assigned in memory 102 to each application that is configured to use the accelerator 106, the accelerator 106 and/or its firmware can be configured to logically bind certain ones of these ring buffers 107 to certain ones of the MEs 109.

In a first possible configuration, each ring buffer 107 is assigned to only ME 109 but one ME 109 can be assigned to multiple ring buffers 107. Here, the dispatcher 108 will assign jobs to a particular ME 109 from the ring buffers 107 that are assigned to that ME. In this case, a particular application may observe delay in the processing of its accelerator invocations if the other application(s) that the application shares its assigned ME 109 with are heavy users of the accelerator 106.

In a second or combined configuration, a single ring buffer 107 that is assigned to one application can be assigned to multiple MEs 109 to, e.g., improve the accelerator’s service rate of the application’s acceleration invocations. In this case, the dispatcher 108 can assign jobs from the application’s ring buffer 107 to any of the multiple MEs 109 that have been assigned to the application.

In another possible configuration, the accelerator firmware and dispatcher 108 logically bind MEs 109 to specific ring buffers 107, and, more than one application can be assigned to a same ring buffer 107 in memory 102 to effect sharing of the ME 109 by the multiple applications. Here, higher priority applications can be assigned their own ring buffer 107 in memory 102 so as to avoid contention/sharing of the buffer’s assigned ME 109 with other applications. Lowest priority applications can be assigned to a ring buffer 107 that not only receives descriptors from multiple applications but also shares its assigned ME 109 with other ring buffers 107.

In essence, there is a multitude of different configuration possibilities as between the assignments of applications to ring buffers 107, the assignments of ring buffers 107 to accelerator MEs 109 and assignments of any internal queues within the accelerator 106 to ring buffers 107 and/or MEs 109 (e.g., in order to effect assignments of ring buffers to MEs).

Returning to the discussion of FIG. 1, after ME 109_1 has been assigned 4 the job for data structure 103, ME 109_1 will attempt to retrieve data structure 103. In order to retrieve data structure 103, ME 109_1 will send 5 a request to an Input/Output Memory Management Unit 110 (IOMMU) that includes a translation table 111 that translates the virtual addresses of the data structures that the accelerator 106 operates upon to the physical address in memory 102 where the data structures are actually located.

Here, the request 5 specifies the virtual address (VA) of data structure 103 and the process ID (PASID) of the application that invoked the accelerator to process data structure 103. The translation table 111 within the IOMMU 110 is structured to list an application’s virtual to physical address translations based on the application’s process ID. The IOMMU 110 then applies the virtual address to the table 111 to obtain the physical address for the data structure and passes the physical address to the accelerator 106 which reads 6 the data structure from memory 102 and passes 7 the data structure to the requesting core 109_1.

The output resultant that is formed by the requesting ME 109_1 upon its completion of its processing of the data structure 103 is placed into an outbound ring buffer in memory 102 (not shown in FIG. 1). When the head pointer of the outbound ring buffer points to the resultant, the resultant is passed from the outbound ring buffer to the CPU core 101.

As described above, there are multiple configurable components of the overall accelerator solution. FIG. 1 depicts four points of configuration P1-P4 that can effect accelerator performance. Here, P1 and P2 pertain to the configuration options of the ring buffer queues 107 (number of ring buffers, assignment of ring buffers to applications, assignment of ring buffers to MEs); P3 pertains to the configuration options of an individual ME (which type of computationally intensive functions are to be performed); and P4 pertains to the configuration of the IOMMU 110 (how many accelerators or other peripherals are configured to use it for memory access, the contents of the translation table 111).

In order to better optimize the accelerator 106 for its constituent applications, statistical monitoring functions (telemetry) are integrated with the four points P1 - P4. The statistical monitoring functions observe and record the performance of their associated circuit structures. Examples include, for P1, the number of entries in each ring buffer, the average number of entries in each ring buffer per unit of time, the rate at which descriptors are being entered into each ring buffer, the rate at which descriptors are being removed each ring, and/or, any other statistics from which these metrics can be determined. P2′s statistics can include statistics concerning the accelerator’s input interface (e.g., the rate at which descriptors are being provided to the accelerator 106), same/similar monitoring statistics as those described just above for P1 but for the accelerator’s internal queue(s) that feed the MEs 109, and/or, the overall accelerator’s utilization (e.g., as a percentage of its maximum throughput, percentage of MEs that are busy over a time interval, as well as any other metrics that measure how heavily or lightly the accelerator is being used).

P3′s statistics can include the rate at which new jobs are being submitted to the ME, the average time consumed by the ME to complete a job, a count for each of the different functions the ME is able to perform under its current configuration (e.g., a first count of encryption jobs and a second count of decryption jobs), and/or, the overall accelerator’s utilization (e.g., as a percentage of its maximum throughput, the number of instructions and/or commands that the ME has executed over a time interval, as well as any other metrics that measure how heavily and/or how lightly the accelerator is being used).

P4′s statistics can measure the state of one or more request queues within the IOMMU 110 that feed(s) the translation table 111, the average time delay consumed fetching data structures from memory 102, the average time consumed processing a translation request, the hit/miss ratio of the virtual-to-physical address translation (a miss being when no entry for a virtual address exists in the IOMMU’s translation table), etc. With respect to the later metric, the IOMMU’s internal table 111 may be akin to a cache that keeps the virtual to physical translations for the applications/PASIDs that are most frequently invoking the IOMMU through accelerator invocations. The complete set of translations are kept in memory 102. If an application invokes the accelerator after a long runtime of not having invoked the accelerator, there is a chance that the application’s translation information will not be resident on the IOMMU’s on-board table 111 (“table miss”) which forces the IOMMU to fetch the application’s translation information from memory 102.

In view of the telemetry data from P4, any of an application or its container in user space and/or a container engine, OS, VM or VMM in kernel space, can try to re-arrange accelerator invocations (e.g., at least for those invocations that do not have data dependencies (one accelerator invocation’s input is another accelerator invocation’s output)) to avoid a table miss in the IOMMU (e.g., by ordering invocations with similar virtual addresses together, by moving forward for execution an invocation whose virtual address has not recently been used but had previously been heavily used, etc.).

Any/all of the above described monitoring statistics, as well as other monitoring statistics not mentioned above, can be recorded in register space of their associated component (e.g., queuing logic 105 for P1, accelerator 106 for P2, etc.) and/or elsewhere on the hardware platform 100 and/or within memory 102.

Ideally, system firmware/software is able to frequently access these monitoring statistics (“telemetry”) so that a deep understanding of the accelerator’s activity and performance can be realized over fine increments of time (e.g., milliseconds, microseconds or less). So doing allows the system firmware/software to, every so often, effect a change in accelerator related configuration, e.g., in view of the current state of the applications that use the accelerator, so that the applications are better served by the accelerator 106.

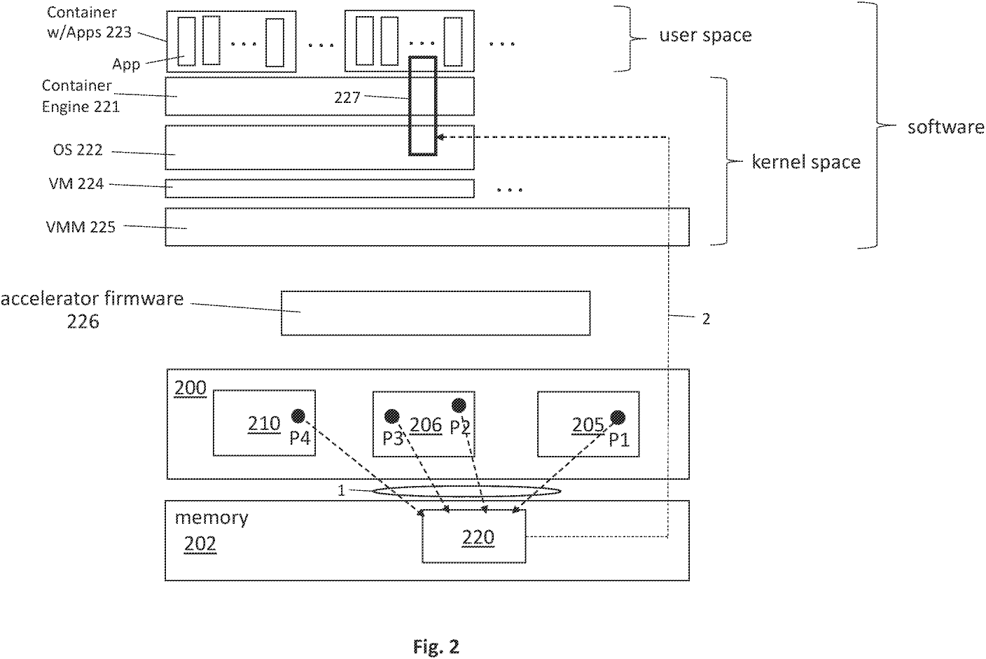

FIG. 2 shows an architecture for rapidly updating the accelerator’s associated statistics and making the statistics readily visible to the applications that use the accelerator and/or software platforms that support the applications.

As observed in FIG. 2, a container engine executes 221 on an operating system (OS) instance 222. The container engine 221 provides “OS level virtualization” for multiple containers 223 that execute on the container engine 221 (for ease of drawing only one container is labeled with a reference number).

A container 223 generally defines the execution environment of the application software programs that execute “within” the container (the application software programs may be micro-services application software programs). For example, a container’s application software programs execute as if they were executing upon a same OS instance and therefore are processed according to a common set of OS/system-level configuration settings, variable states, execution states, etc.

The container’s underlying operating system instance 222 executes on a virtual machine (VM) 224. A virtual machine monitor 225 (also referred to as a “hypervisor”) supports the execution of multiple VMs which, in turn, each support their own OS instance and corresponding container engine and containers (for ease of drawing, only one VM 224 is depicted executing upon the VMM 225).

The above described software is physically executed on the CPU cores of the hardware platform 200 (for ease of drawing, the CPU cores are not shown in FIG. 2). The CPU cores are capable of concurrently executing a plurality of threads, where, a thread is typically viewed as a stream of program code instructions. The different software programs often correspond to different “processes” to which one or more threads can be allocated.

Here, the aforementioned applications that use the accelerator 206 execute within the software platform’s containers. Thus, the architecture of FIG. 2 enables the accelerator statistics that are collected in register space associated with the queuing logic 205 at P1, the accelerator 206 at P2, P3 and the IOMMY 207 at P4 are quickly made available to the applications and are rapidly updated so that the applications can observe the accelerator’s statistics in real time or quasi real time.

Specifically, the accelerator firmware 226 runs a continuous loop that repeatedly (e.g., periodically/isochronously, with irregular intervals, etc.) reads the statistics from their respective registers within the hardware platform 200 and then writes them into one or more physical file structures 220 in memory 202 and/or non volatile mass storage. Concurrently with the accelerator firmware’s continuous loop, the accelerator’s device driver software 227 repeatedly (e.g., periodically/isochronously, with irregular intervals, etc.) reads 2 the one or more physical file structures 220 and makes the statistics available to the applications.

Here, because the applications are executing in a virtualized environment, the statistics can be made visible through the use of physical-file-to-virtual-file commands/communications (e.g., sysfs in Linux). For example, according to one approach, the accelerator firmware 226 records the accelerator’s statistics on a software process by software process basis. Recalling the discussion of FIG. 2, the accelerator firmware receives a PASID with each descriptor that identifies which process generated the descriptor.

The accelerator firmware 226 can therefore be written to observe the performance of the accelerator at each of points P1, P2, P3 and P4 with respect to the PASID/process and record accelerator statistics in the file(s) 220, e.g., on a PASID by PASID basis (the statistics as recorded in file(s) 220 separate accelerator performance on a PASID by PASID basis). Here, each application has an associated virtual file for its accelerator statistics and the device driver 227 performs the physical-file-to-virtual-file transformation that allows a particular application to observe the accelerator’s performance for that application.

Again, the updating 1 of the physical file(s) 220 by the firmware 227 is continuous as is the updating 2 of the applications’ respective virtual files so as to enable “real time” observation by the applications of the accelerator’s performance on behalf of the applications (e.g., updating 1, 2 occurs every second, every few seconds, etc.). In another or combined approach, the application can see updated accelerator metrics each time the accelerator is presented with a new job. This “real time” observation allows each application to correlate accelerator performance with the application workload (e.g., the application can see how well the accelerator 206 responds to moments when the application places a heavy workload on the accelerator 206). If accelerator 206 performance is unsatisfactory, the application can request accelerator reconfiguration and/or raise a flag that causes deeper introspection (e.g., by system management) into the current accelerator configuration.

A configuration change can affect an accelerator’s ME(s) and/or internal queuing configuration and/or the external ring buffer configurations that feed the accelerator 206. In advanced systems, e.g., based on long term observation of application and accelerator performance over time (machine learned or otherwise), reconfigurations are effected in advance of an anticipated change in application workload (the accelerator is configured to a new configuration that better serves the application once the workload change occurs).

The accelerator’s device driver 227 can include a portion that operates in user space within the container (e.g., the API for invoking the accelerator) and one or more other portions that operate in kernel space (as part of the container engine 221 and/or OS 222) to better communicate with the accelerator firmware 206. In various embodiments, the portion(s) that operate in kernel space are written to perform the rapid updating 2 and virtual-to-physical file transformations.

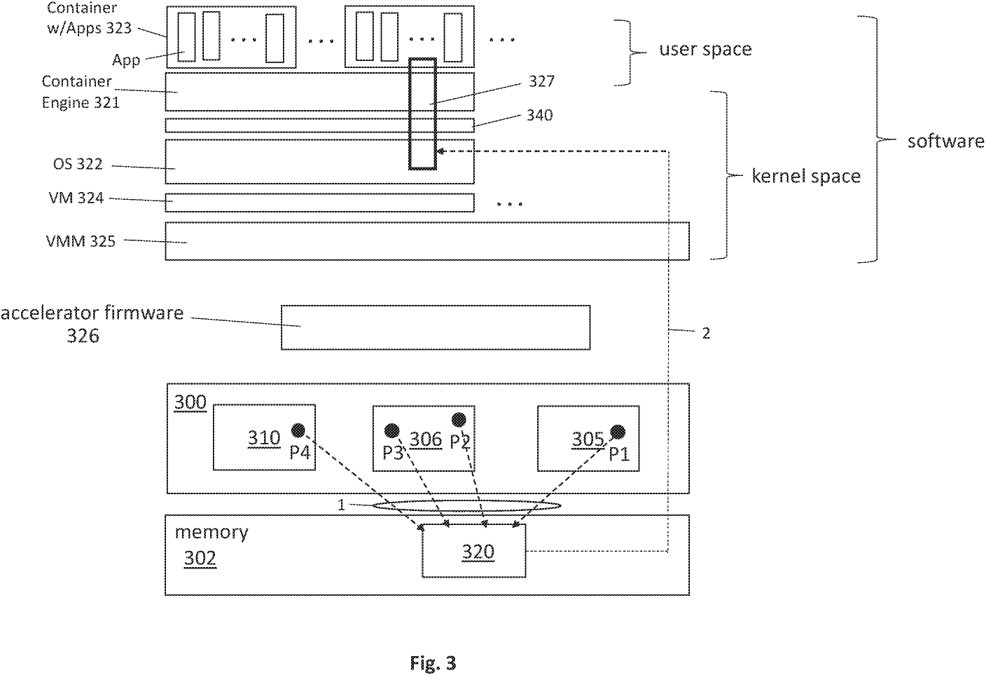

In further embodiments, as observed in FIG. 3, the device driver 327, or component thereof, plugs into a larger monitoring framework 340 that monitors additional system components besides the accelerator 306. For example, as observed in FIG. 3, framework 340 presents accelerator statistics, CPU statistics, networking interface statistics, storage system statistics, power management statistics, etc. that describe/characterize the performance of the hardware platform 300 resources that have been allocated to the container engine 321. The container engine 321 can then further determine how these resources are being allocated to each container that the container engine supports and present them to each container’s respective applications.

In various embodiments, the monitoring framework 340 presents statistics that are time averaged or otherwise collected over extended time lengths. As such, with respect to the accelerator 306, the applications can obtain immediate, real-time statistics owing to the rapid updating activity 1, 2 of the accelerator firmware 326 and device driver 327 as well as longer runtime statistics as collected and presented through the framework 340. The telemetry framework 340 can be implemented and/or integrated with various existing telemetry solutions (such as collectd, telegraf, node_exporter, cadvisor, etc.).

The hardware platform 200, 300 of FIGS. 2 and 3, respectively can be implemented in various ways. For example, as described above, according to one approach, the hardware platform 200, 300 is a system-on-chip (SOC) semiconductor chip. In this case, the CPU(s) that execute the application(s) that invoke the accelerator 206, 306 can be general purpose processing cores that are disposed on the semiconductor chip and the accelerator 206, 306 can be a fixed function ASIC block, special purpose processing core, etc. that is disposed on the same semiconductor chip. Note that in this particular approach, the CPU core(s) and accelerator 206, 306 are within a same semiconductor chip package. The IOMMU 210, 310 can be integrated within the accelerator 206, 306 so that it is dedicated to the accelerator 206, 306, or, can be external to the accelerator 206, 306 so that it performs virtual/physical address translation and memory access for other accelerators/peripherals on the SOC. In another similar approach, at least two semiconductor chips are used to implement the CPU core(s), accelerator 206, 306, the IOMMU 210, 310 and the memory 207, 307 and both chips are within a same semiconductor chip package.

In another approach, the hardware platform 200, 300 is an integrated system, such as a server computer. Here, the CPU core(s) can be a multicore processor chip disposed on the server’s motherboard and the accelerator 206 can be, e.g., disposed on a network interface card (NIC) that is plugged into the computer. In another approach, the hardware platform 200, 300 is a disaggregated computing system in which different system component modules (e.g., CPUs, storage, memory, acceleration) are plugged into one or more racks and are communicatively coupled through one or more networks.

In various embodiments the accelerator 206, 306 can perform one of compression and decompression (compression/decompression) and one of encryption and decryption (encryption/decryption) in response to a single invocation by an application.

Although embodiments above have focused on the delivery of the accelerator’s telemetry data to an application in user space, in other implementations kernel space software programs (e.g., container engine, OS, VM, VMM, etc.) receive and/or access the telemetry data of any/all of points P1-P4 to inform themselves of accelerator related hardware performance. For example, in a hardware platform having multiple accelerators, a VMM may reassign which VMs are assigned to which accelerators based on any/all of the accelerator telemetry described above. The kernel space programs can access the telemetry from the virtual files and/or directly from the physical files.

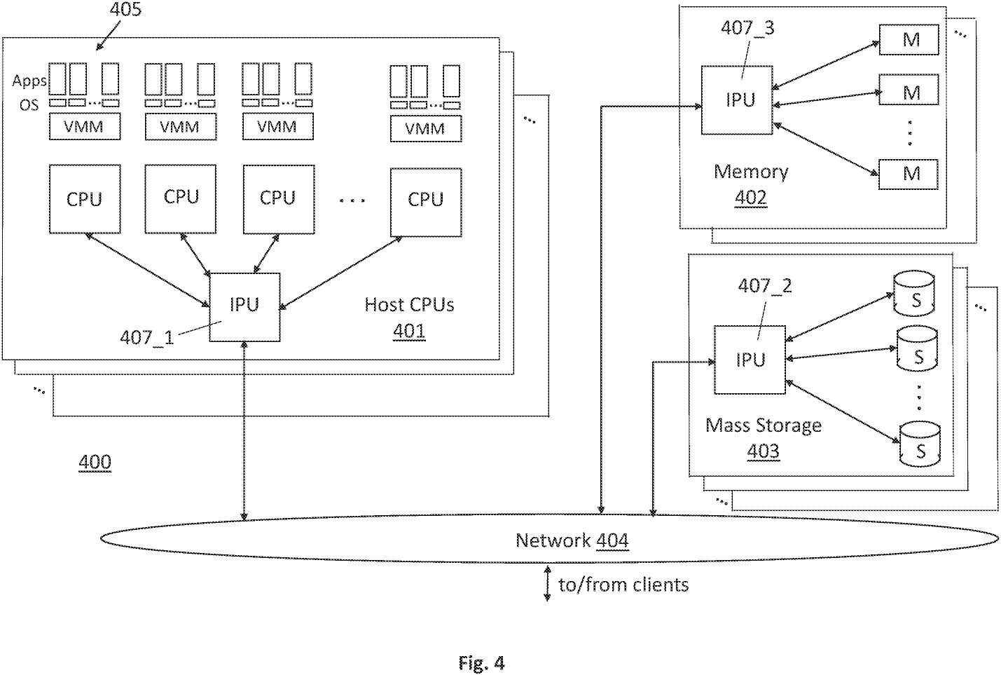

FIG. 4 shows a new, emerging computing environment (e.g., data center) paradigm in which “infrastructure” tasks are offloaded from traditional general purpose “host” CPUs CPUs (where application software programs are executed) to an infrastructure processing unit (IPU), data processing unit (DPU) or smart networking interface card (SmartNIC), any/all of which are hereafter referred to as an IPU.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.).

Remote clients invoke/use these applications through temporary network sessions/connections that are established by the data center between the clients and the applications. A recent trend is to strip down the functionality of at least some of the applications into more finer grained, atomic functions (“micro-services”) that are called by client programs as needed. Micro-services typically strive to charge the client/customers based on their actual usage (function call invocations) of the micro-service application.

In order to support the network sessions and/or the applications’ functionality, however, certain underlying computationally intensive and/or trafficking intensive functions (“infrastructure” functions) are performed.

Examples of infrastructure functions include encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications However, the intensity of the infrastructure functions has begun to affect the ability of the CPUs to perform their end-function applications in a timely manner relative to the expectations of the clients, and/or, perform their end-functions in a power efficient manner relative to the expectations of data center operators. Moreover, the CPUs, which are typically complex instruction set (CISC) processors, are better utilized executing the processes of a wide variety of different application software programs than the more mundane and/or more focused infrastructure processes.

As such, as observed in FIG. 4, the infrastructure functions are being migrated to an infrastructure processing unit. FIG. 4 depicts an exemplary data center environment 400 that integrates IPUs 407 to offload infrastructure functions from the host CPUs 404 as described above.

As observed in FIG. 4, the exemplary data center environment 400 includes pools 401 of CPU units that execute the end-function application software programs 405 that are typically invoked by remotely calling clients. The data center 400 also includes separate memory pools 402 and mass storage pools 405 to assist the executing applications. The CPU, memory storage and mass storage pools 401, 402, 403 are respectively coupled by one or more networks 404.

Notably, each pool 401, 402, 403 has an IPU 407_1, 407_2, 407_3 on its front end or network side. Here, each IPU 407 performs pre-configured infrastructure functions on the inbound (request) packets it receives from the network 404 before delivering the requests to its respective pool’s end function (e.g., executing software in the case of the CPU pool 401, memory in the case of memory pool 402 and storage in the case of mass storage pool 403). As the end functions send certain communications into the network 404, the IPU 407 performs pre-configured infrastructure functions on the outbound communications before transmitting them into the network 404.

Depending on implementation, one or more CPU pools 401, memory pools 402, mass storage pools 403 and network 404 can exist within a single chassis, e.g., as a traditional rack mounted computing system (e.g., server computer). In a disaggregated computing system implementation, one or more CPU pools 401, memory pools 402, and mass storage pools 403 are, e.g., separate rack mountable units (e.g., rack mountable CPU units, rack mountable memory units (M), rack mountable mass storage units (S)).

In various embodiments, the software platform on which the applications 405 are executed include a virtual machine monitor (VMM), or hypervisor, that instantiates multiple virtual machines (VMs). Operating system (OS) instances respectively execute on the VMs and the applications execute on the OS instances. Container engines (e.g., Kubernetes container engines) respectively execute on the OS instances. The container engines provide virtualized OS instances and containers execute on the virtualized OS instances. The containers provide isolated execution environment for a suite of applications which can include, applications for micro-services.

With respect to the hardware platform 200, 300 of the improved accelerator monitoring processes described just above with respect to FIGS. 2 and 3, in various embodiments, the hardware platform 200, 300 corresponds to the paradigm of FIGS. 2 and 3 in which the CPUs within the platform 200, 300 corresponds to one or more CPUs within a CPU pool 401, the memory 202, 302 corresponds to one or memory units within the memory pool 402 and the accelerator 206, 306 is a component within an accelerator/acceleration pool that is not depicted in FIG. 4 but follows the same approach as the other pools 401, 402, 403 (multiple accelerators are coupled to network 404 through an IPU).

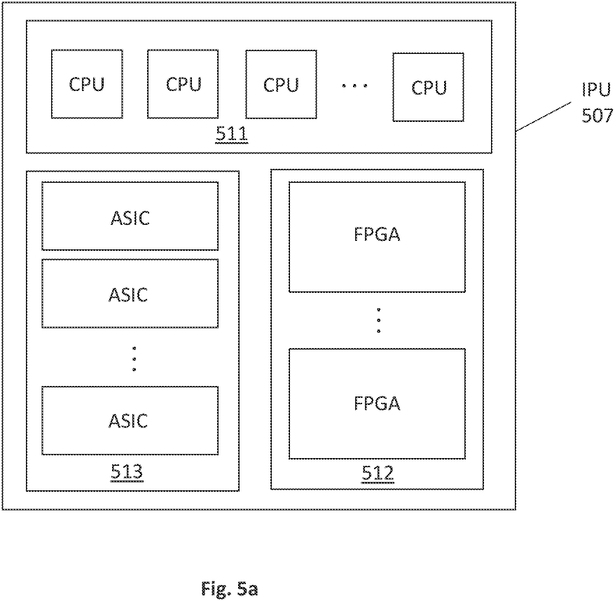

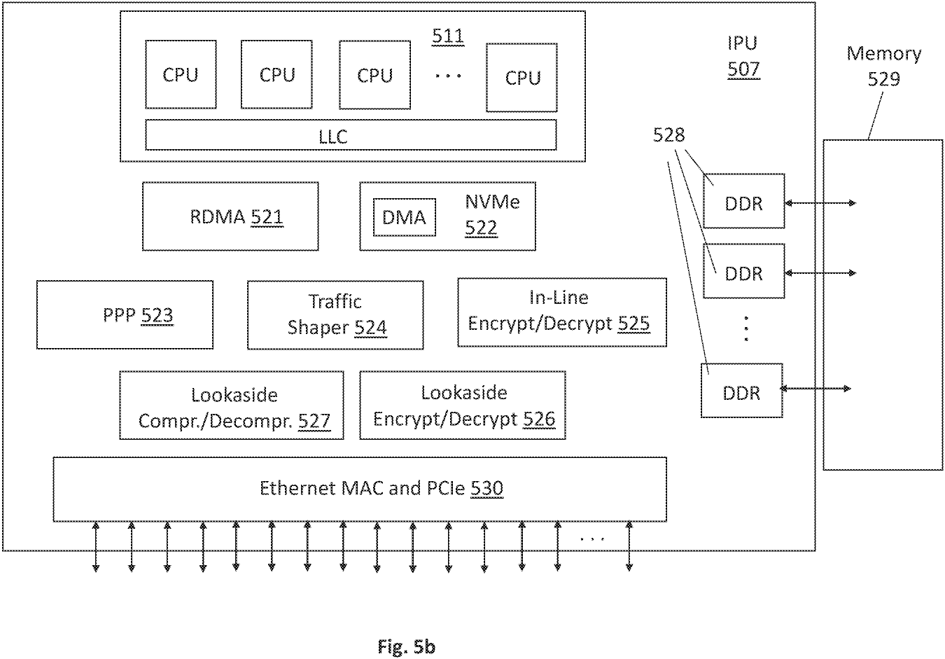

FIG. 5a shows an exemplary IPU 507. As observed in FIG. 5 the IPU 509 includes a plurality of general purpose processing cores (CPUs) 511, one or more field programmable gate arrays (FPGAs) 512, and/or, one or more acceleration hardware (ASIC) blocks 513. An IPU typically has at least one associated machine readable medium to store software that is to execute on the processing cores 511 and firmware to program the FPGAs (if present) so that the processing cores 511 and FPGAs 512 (if present) can perform their intended functions.

With respect to the hardware platform 200, 300 of the improved accelerator monitoring processes described just above with respect to FIGS. 2 and 3, in various embodiments, the hardware platform 200, 300 is an IPU 407 in which the platform CPU(s) correspond to one or more CPUs 511 and the accelerator 506 is an FPGA 512 or an ASIC block 513.

The processing cores 511, FPGAs 512 and ASIC blocks 513 represent different tradeoffs between versatility/programmability, computational performance and power consumption. Generally, a task can be performed faster in an ASIC block and with minimal power consumption, however, an ASIC block is a fixed function unit that can only perform the functions its electronic circuitry has been specifically designed to perform.

The general purpose processing cores 511, by contrast, will perform their tasks slower and with more power consumption but can be programmed to perform a wide variety of different functions (via the execution of software programs). Here, it is notable that although the processing cores can be general purpose CPUs like the data center’s host CPUs 401, in various embodiments the IPU’s general purpose processors 511 are reduced instruction set (RISC) processors rather than CISC processors (which the host CPUs 401 are typically implemented with). That is, the host CPUs 401 that execute the data center’s application software programs 405 tend to be CISC based processors because of the extremely wide variety of different tasks that the data center’s application software could be programmed to perform.

By contrast, the infrastructure functions performed by the IPUs tend to be a more limited set of functions that are better served with a RISC processor. As such, the IPU’s RISC processors 511 should perform the infrastructure functions with less power consumption than CISC processors but without significant loss of performance.

The FPGA(s) 512 provide for more programming capability than an ASIC block but less programming capability than the general purpose cores 511, while, at the same time, providing for more processing performance capability than the general purpose cores 511 but less than processing performing capability than an ASIC block.

FIG. 5b shows a more specific embodiment of an IPU 507. The particular IPU 507 of FIG. 5b does not include any FPGA blocks. As observed in FIG. 5b the IPU 507 includes a plurality of general purpose cores (e.g., RISC) 511 and a last level caching layer for the general purpose cores 511. The IPU 507 also includes a number of hardware ASIC acceleration blocks including: 1) an RDMA acceleration ASIC block 521 that performs RDMA protocol operations in hardware; 2) an NVMe acceleration ASIC block 522 that performs NVMe protocol operations in hardware; 3) a packet processing pipeline ASIC block 523 that parses ingress packet header content, e.g., to assign flows to the ingress packets, perform network address translation, etc.; 4) a traffic shaper 524 to assign ingress packets to appropriate queues for subsequent processing by the IPU 509; 5) an in-line cryptographic ASIC block 525 that performs decryption on ingress packets and encryption on egress packets; 6) a lookaside cryptographic ASIC block 526 that performs encryption/decryption on blocks of data, e.g., as requested by a host CPU 401; 7) a lookaside compression ASIC block 527 that performs compression/decompression on blocks of data, e.g., as requested by a host CPU 401; 8) checksum/cyclic-redundancy-check (CRC) calculations (e.g., for NVMe/TCP data digests and/or NVMe DIF/DIX data integrity); 9) thread local storage (TLS) processes; etc.

The IPU 507 also includes multiple memory channel interfaces 528 to couple to external memory 529 that is used to store instructions for the general purpose cores 511 and input/output data for the IPU cores 511 and each of the ASIC blocks 521 - 526. The IPU includes multiple PCIe physical interfaces and an Ethernet Media Access Control block 530 to implement network connectivity to/from the IPU 509. As mentioned above, the IPU 507 can be a semiconductor chip, or, a plurality of semiconductor chips integrated on a module or card (e.g., a NIC).

Embodiments of the invention may include various processes as set forth above. The processes may be embodied in program code (e.g., machine-executable instructions). The program code, when processed, causes a general-purpose or special-purpose processor to perform the program code’s processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
repeatedly performing a) below:
a) reading accelerator telemetry data from register and/or memory space allocated for the keeping of the accelerator telemetry data and writing the accelerator telemetry data into a physical file structure within memory and/or mass storage, wherein, the accelerator telemetry data describes an input/output memory management unit’s performance regarding its translation of virtual addresses to physical addresses for the accelerator; and,
repeatedly performing b) below:
b) reading the accelerator telemetry data from the physical file structure and storing the accelerator telemetry data into virtual files that are visible to application software programs that invoke the accelerator.

2. The method of claim 1 wherein the repeated writing into the physical file structure of a) occurs in periods of time that are less than a second.

3. The method of claim 2 wherein the repeated reading from the physical file structure of b) occurs in periods of time that are less than a second.

4. The method of claim 1 wherein a) is performed by the accelerator’s firmware.

5. The method of claim 1 wherein b) is performed by the accelerator’s device driver.

6. The method of claim 1 wherein the accelerator telemetry data includes telemetry data for queuing structures that feed the accelerator and accelerator utilization.

7. The method of claim 1 wherein the accelerator telemetry data is organized within the physical data structure according to identifiers of respective CPU processes that execute the application software programs.

8. A machine readable medium containing program code that when processed by a plurality processors causes a method to be performed, the method comprising:
repeatedly performing a) below:
a) reading accelerator telemetry data from register and/or memory space allocated for the keeping of the accelerator telemetry data and writing the accelerator telemetry data into a physical file structure within memory and/or mass storage, wherein, the accelerator telemetry data describes an input/output memory management unit’s performance regarding its translation of virtual addresses to physical addresses for the accelerator; and,
repeatedly performing b) below:
b) reading the accelerator telemetry data from the physical file structure and storing the accelerator telemetry data into virtual files that are visible to application software programs that invoke the accelerator.

9. The machine readable medium of claim 8 wherein the repeated writing into the physical file structure of a) occurs in periods of time that are less than a second.

10. The machine readable medium of claim 9 wherein the repeated reading from the physical file structure of b) occurs in periods of time that are less than a second.

11. The machine readable medium of claim 8 wherein a) is performed by the accelerator’s firmware.

12. The machine readable medium of claim 8 wherein b) is performed by the accelerator’s device driver.

13. The machine readable medium of claim 8 wherein the accelerator telemetry data includes telemetry data for queuing structures that feed the accelerator and accelerator utilization.

14. The machine readable medium of claim 8 wherein the accelerator telemetry data is organized within the physical data structure according to identifiers of respective CPU processes that execute the application software programs.

15. A data center, comprising:
a pool of accelerators;
a pool of CPUs to execute application software programs that invoke the pool of accelerators;
a network coupled between the pool of accelerators and the pool of CPUs;
a first machine readable storage medium containing first program code that when processed by a first processor causes a first method to be performed comprising repeatedly reading accelerator telemetry data from register and/or memory space allocated for the keeping of the accelerator telemetry data and writing the accelerator telemetry data into a physical file structure within memory and/or mass storage, wherein, the accelerator telemetry data describes an input/output memory management unit’s performance regarding its translation of virtual addresses to physical addresses for the accelerator; and,
a second machine readable storage medium containing second program code that when processed by a second processor causes a second method to be performed comprising repeatedly reading the accelerator telemetry data from the physical file structure and storing the accelerator telemetry data into virtual files that are visible to the application software programs.

16. The data center of claim 15 wherein the first program code is the accelerator’s firmware.

17. The data center of claim 15 wherein the second program code is the accelerator’s device driver.

18. The data center of claim 17 wherein the second program code is plugged into a framework that monitors telemetry data for hardware components other than the accelerator.

19. The data center of claim 15 wherein the accelerator telemetry data includes telemetry data for queuing structures that feed an accelerator and accelerator utilization.

20. The method of claim 15 wherein the accelerator telemetry data is organized within the physical data structure according to identifiers of respective CPU processes that execute the application software programs.
